(19) United States
(12) Patent Application Publication
(10) Pub. No.: US 2004/0203370 A1
(43) Pub. Date: Oct. 14, 2004

(54) Wireless gateway node

(76) Inventors: Yi Luo, Dearborn Heights, MI (US); Tom Tang, Novi, MI (US); John Nantz, Brighton, MI (US); Ron King, Dearborn, MI (US); Riad Ghabra, Dearborn Heights, MI (US); Tom LeMense, Farmington, MI (US)

Correspondence Address: ARTZ & ARTZ, P.C., 28333 TELEGRAPH RD., SUITE 250, SOUTHFIELD, MI, 48034, US

(21) Appl. No.: 10/260,982

(22) Filed: Sep. 30, 2002

(51) Int. Cl. H04B 5/00; G08G 1/123

(52) U.S. Cl. 455/41.2; 340/991; 455/456.1

(57) ABSTRACT

A wireless gateway node (12) for an automotive vehicle (10) includes a transceiver (22), digital processing circuit (26), and an interface (28) that is used to receive wireless gateway signals and couple the signals to control system (16) of automotive vehicle (10). Wireless gateway node (12) allows two-way communication between various wireless communication devices such as personal digital assistants and laptop computers. The transceiver (22) may be reconfigurable to allow communication with several different types of devices using different communication protocols.

### TECHNICAL FIELD

The present invention relates generally to a communication device for automotive vehicles, and more specifically, to a gateway device to allow wireless devices to communicate with control systems within the vehicle.

### BACKGROUND

Automotive vehicles typically include several control systems. The control systems are typically microprocessor-based and control various functions of the vehicle. More and more functions and therefore more and more microprocessors are being incorporated into the vehicle. Navigation systems, dynamic control systems, personal computers, and other computing devices are increasingly available on automotive vehicles.

The proliferation of wireless devices such as Bluetooth devices, personal digital assistants, wireless laptop computers, and other devices are readily used by vehicle operators in their personal and business lives. However, as the functionality of vehicles increases it will be desirable for various types of personal communication devices to interface with various vehicle control systems.

### SUMMARY OF THE INVENTION

The present invention provides an interface so that personal communication devices may interface with control systems of the vehicle.

In one aspect of the invention, a gateway node is provided that includes a transceiver coupled to a digital signal processing circuit. The digital signal processing circuit is coupled to an interface block. The transceiver receives communication signals from the personal communication device and converts them to digital signals which are processed in the digital signal processor. The digital signals are coupled to control systems of the vehicle through an interface block. The interface block formats the digital signals to communicate with the vehicle.

In a further aspect of the invention, a method for coupling a wireless device to a vehicle control system comprises receiving a communication signal using a predetermined format, processing the communication signal into a digital signal corresponding to the communication signal, and coupling the signal to a vehicle controller. The method may also include receiving communication signals from the control systems of the vehicle, processing the digital signals into a communication signal, and wirelessly transmitting the communication signals to a personal communication device.

One advantage of the invention is that the transceiver may also be microprocessor controlled to provide the functionality of various types of communication including UHF, Bluetooth, GPS, wireless LAN, infrared and digital audio broadcasting. Because the device is microprocessor-based, the microprocessor therein may be easily reprogrammed to incorporate new types of communication protocols.

A further advantage of the invention is that various personal communication devices may be interfaced to the vehicle to provide many types of functions. For example, a personal digital assistant may be used to provide remote keyless entry functions for the vehicle. Of course, those skilled in the art will recognize various other types of communications including interfacing with the navigation system to provide or capture position data.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a high level block diagrammatic view of a wireless gateway node coupling a personal communication device with an automotive control system.

FIG. 2 is a more detailed block diagram of the wireless gateway node according to FIG. 1.

FIG. 3 is a flow chart of the operation of the present invention.

### DESCRIPTION OF THE PREFERRED EMBODIMENT

In the following figures the same reference numerals are used to identify the same components. The present invention is described with various types of communication protocols. However, the transceiver described is preferably reconfigurable and therefore the communication protocol may be changed as different types of communication protocols are developed.

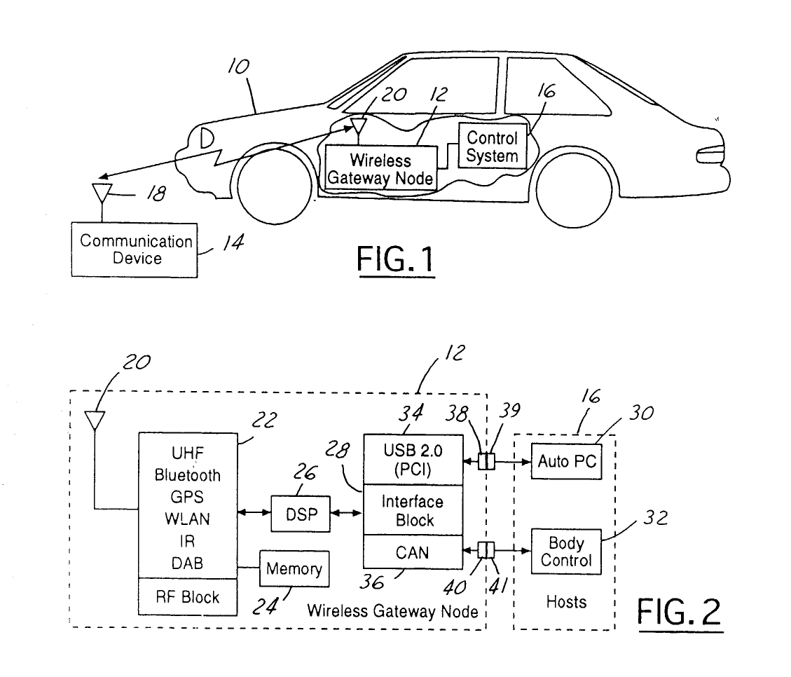

Referring now to FIG. 1, an automotive vehicle 10 includes a wireless gateway node 12 that couples a wireless communication device 14 with a control system 16 of the automotive vehicle. The communication device 14 may be one of a variety of communication devices including but not limited to a wireless personal digital assistant, a laptop computer, and a cellular telephone.

Control system 16 may be one of a variety of different types of control systems within the vehicle. Control system 16 may include an automotive personal computer, engine control, remote keyless entry system, vehicle dynamic system, or one of a variety of types of electrical control systems.

The communication device 14 has an antenna 18 that is used to transmit and receive the various communication signals. Of course, one or more antennas may be provided including a infrared detector and transmitter such as an LED, if infrared signals are used as the communication signals. Wireless gateway node 12 has an antenna 20 that is also used to transmit and receive signals. Those skilled in the art will recognize that one-way communication between communication device 14 and wireless gateway node 12 or vice-versa may be performed by the present invention.

Referring now to FIG. 2, wireless gateway node 12 is illustrated in further detail. Antenna 20 is coupled to a transceiver 22 that may also be referred to as an RF block. Transceiver 22 is preferably microprocessor-based that allows for reconfigurability thereof. Transceiver 22 is configured to communicate (transmit and receive) using one or more protocols. For example, transceiver 22 may include the radio frequency parts of a UHF transceiver, a Bluetooth transceiver, an infrared transceiver, a global positioning transceiver, a Wi-Fi system, and/or a digital audio broadcasting system. Of course, only one protocol may be supported. When several protocols are provided maximum flexibility is obtained for the system.

By allowing reconfigurability, the structure is open and makes it upgradeable. The upgrading capability can be simplified to allow end users the ability to reconfigure the system. Reconfigurability may take place using software commands or by the insertion of a circuit board (plug and play) having circuitry associated with the reconfiguration into the system in a similar manner to a personal computer. The inserted circuit board is electrically coupled to the transceiver and the microprocessor associated therewith.

Memory 24 may be one of a variety of types of memory including but not limited to RAM, ROM or keep alive. The antenna 22 receives wireless communication signals. The transceiver 22 is used to transmit and communicate the wireless communication signals through antenna 20.

Transceiver 22 may also be coupled to a memory 24 that is used to store various information including the protocol formats and as a cache-type memory.

A digital signal processor 26 is illustrated coupled to transceiver 22. Those skilled in the art will recognize that both memory 24 and digital signal processor 26 may be incorporated as part of transceiver 22. However, to illustrate the separate functionality, both memory 24 and digital signal processor 26 are illustrated as separate components. Transceiver 22 receives the wireless communication signals and converts them to digital signals and vice-versa in transmit mode. However, digital signal processor 26 may also convert the communication signals into digital signals. Digital signal processor 26 may digitally filter or otherwise process the signals to reduce errors therein. Various filtering schemes will be evident to those skilled in the art.

Digital signal processor is coupled to an interface block 28 that is coupled ultimately to control system 16 of the automotive vehicle 10. Interface block 28 receives the digital signals from digital signal processor 26 and routes them to various parts of control system 16 within automotive vehicle 10. Interface block 28 may format the digital signals into formatted digital signals capable of communicating with the vehicle systems. The same is true in reverse in that the formatted signals from the vehicle may be converted to another format before being transmitted from the gateway node 12. As illustrated, an automotive personal computer 30 and a body controller may be a portion of control system 16. As illustrated, interface block 28 may include a universal serial bus (USB) or PCI portion 34 and a car area network (CAN) portion 36. Both USB portion 34 and care area network portion 36 may include a respective connector 38 and 40 which are coupled to a mating connector 39 and 41, respectively. Connectors 39 and 41 may be a portion of automotive vehicle 10. If wireless gateway node 12 is integrally formed within the automotive vehicle, the interface block 28 may be hardwired into the control system 16 of automotive vehicle 10.

By coupling the wireless gateway node 12 to the automotive vehicle 16, various functions may now be enabled. One possibility is that the communication device may be used as a remote keyless entry transceiver. The wireless device may also transmit and receive navigation information such as position data capture. Diagnostics and other configuration functions may also be performed. The digital audio broadcasting portion allows CD-like audio quality to be transmitted to the vehicle with no interference common in RF reception. Thus, text, picture, data and video may be exchanged between the vehicle and the communication device 14.

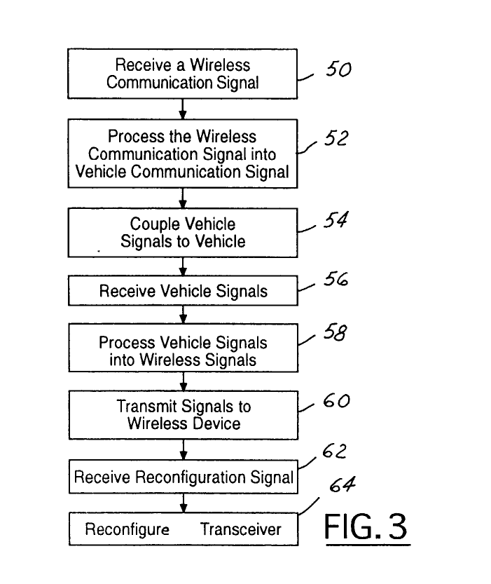

Referring now to FIG. 3, the operation of the wireless device will be now described. In step 50 a wireless communication signal is received from a communication device 14 illustrated above. In step 52 the wireless communication signal is processed to form a vehicle communication signal 52. In step 54 the vehicle communication signal is coupled to the vehicle through interface 28. The vehicle then processes the signals or performs the various functions using the control system to which it is coupled.

In step 56 the vehicle may respond to the wireless communication device through the wireless gateway node 12. The vehicle generates signals which are received at the wireless gateway node. In step 58 the vehicle communication signals are converted and processed into the desired communication protocol. In step 60, the signals are transmitted to the wireless communication device using the transceiver and the antenna of the wireless gateway node.

In step 62, if the transceiver is desired to be reconfigured, a reconfiguration signal may be generated by the handheld device and received by the wireless gateway node. In step 64 the reconfiguration signal reconfigures the device. Reconfiguration may take many forms including reconfiguring the protocol or various other functions associated with the transceiver.

Advantageously, the reconfiguration of the system allows flexibility for future protocols to be incorporated into the device. By incorporating several types of protocols in a device, the gateway node 12 has maximum flexibility. The system may also allow for various types of servicing devices by both an end user and service personnel.

While particular embodiments of the invention have been shown and described, numerous variations and alternate embodiments will occur to those skilled in the art. Accordingly, it is intended that the invention be limited only in terms of the appended claims.

What is claimed is:

1. A wireless gateway node comprising:
a transceiver for transmitting and receiving wireless communication signals;
a signal processing circuit for digitally processing the wireless communication signals to and from digital communication signals in a predetermined format; and
a wired interface for coupling the digital communication signals between the signal processing circuit a controller.

2. A wireless gateway node as recited in claim 1 wherein the transceiver is reconfigurable.

3. A wireless gateway node as recited in claim 1 wherein the wireless interface comprises a universal series bus interface.

4. A wireless gateway node as recited in claim 1 wherein the universal series bus interface comprises a USB connector.

5. A wireless gateway node as recited in claim 1 wherein the interface comprises a car area network interface.

6. A communication system for communicating between a wireless communication device and a control system of an automotive vehicle comprising:
a transceiver receiving received wireless communication signals from the wireless communication device and transmitting vehicle wireless communication signals to the wireless communication device;
a signal processing circuit for digitally processing the received wireless communication signals into received digital communication signals and processing the vehicle communication signals into the vehicle wireless communication signals using a predetermined format; and
a wired interface for coupling the received digital communication signals and the vehicle communication signals between the signal processing circuit a controller.

7. A system as recited in claim 6 wherein the transceiver is reconfigurable.

8. A system as recited in claim 6 wherein the wireless interface comprises a universal series bus interface.

9. A system as recited in claim 6 wherein the universal series bus interface comprises a USB connector.

10. A system as recited in claim 6 wherein the interface comprises a car area network interface.

11. A system as recited in claim 6 wherein the interface is coupled to a first connector portion for coupling to a second connector portion of an automotive vehicle.

12. A system as recited in claim 6 wherein the wired interface is hard wired to the control system.

13. A method for communicating between a wireless device and a vehicle controller comprising:
receiving wireless communication signals in a predetermined format;
processing the wireless communication signals into digital signals corresponding to the communication signals; and
coupling the digital signals into a vehicle controller.

14. A method as recited in claim 13 further comprising receiving vehicle digital signals;
processing the vehicle digital signals into vehicle communication signals using the predetermined format; and
wirelessly transmitting the vehicle communication signals to a communication device.

15. A method as recited in claim 13 wherein receiving comprises receiving communication signal in a number of predetermined formats.

16. A method as recited in claim 13 wherein coupling the digital signal comprises coupling the digital signals comprises coupling the digital signal through a wired interface.

17. A method as recited in claim 13 further comprising reconfiguring a transceiver into a second format.

18. A method as recited in claim 17 wherein reconfiguring a transceiver into a second format comprises generating a reconfiguration signal at a communication device.

19. A method as recited in claim 18 wherein generating a reconfiguration signal at a communication device comprises generating a reconfiguration signal at a wireless communication device.

20. A method as recited in claim 13 further comprising operating a control function in a control system in response the communication signals.
